(19) United States
(12) Patent Application Publication
(10) Pub. No.: US 2026/0350579 A1
(43) Pub. Date: Nov. 5, 2026

(54) Unified Electronic Payment Retrofit System for Payment-Operated Machines with Multi-Source Transaction Monitoring

(71) Applicant: PixelPay Inc., Cheyenne, WY (US)

(72) Inventor: Branson Montgomery, Cheyenne, WY (US)

(73) Assignee: PixelPay Inc., Cheyenne, WY (US)

(21) Appl. No.: 19/441,259

(22) Filed: Jan. 6, 2026

Related U.S. Application Data
(60) Provisional application No. 63/800,244, filed on May 5, 2025.

(51) Int. Cl. G06Q 20/32; G07F 17/32

(52) U.S. Cl. CPC G06Q 20/3276; G07F 17/3246

(57) ABSTRACT

A unified electronic control board retrofits payment-operated machines with three isolated listener inputs using JST-XH parallel taps for simultaneous monitoring of two coin channels and one bill/ticket acceptor without modifying existing circuitry. The system comprises an ESP32-S3 microcontroller with direct-to-cloud WiFi communication, optocoupled relay modules generating precise pulse injection matching OEM characteristics, tri-modal power configuration supporting barrel jack and JST-XH/VH connectors, and LED diagnostics indicating power status. Machine-specific QR codes enable electronic payments through cloud-based validation while preserving original machine functionality. High-impedance parallel tapping ensures signal integrity for comprehensive transaction monitoring and analytics across all payment sources.

### CROSS REFERENCE TO RELATED APPLICATIONS

This application claims the benefit of priority under 35 U.S.C. § 119(e) to U.S. Provisional Patent Application No. 63/800,244, filed May. 5, 2025, titled "System and Method for Non-Invasive Electronic Payment Retrofit of Coin-Operated Machines with Integrated Analytics," which is hereby incorporated by reference in its entirety.

### BACKGROUND OF THE INVENTION

Payment-operated machines, such as arcade games, vending machines, laundry machines, and parking meters, have traditionally relied on physical currency mechanisms that present numerous operational challenges. These mechanisms are inherently mechanical in nature, requiring routine maintenance, repair, and eventual replacement when parts become unavailable or obsolete. The mechanical nature of these systems creates multiple potential points of failure that can lead to machine downtime and lost revenue.

The current landscape of payment-operated machines faces significant challenges due to changing consumer payment preferences. With fewer people carrying physical currency, particularly coins, businesses that rely on coin-operated or bill-operated machines face declining accessibility and usage. This shift in consumer behavior particularly impacts sectors such as arcades, laundromats, and parking services, where traditional payment mechanisms remain prevalent.

Existing attempts to modernize these systems through RFID cards and proprietary payment solutions have introduced new complications. These systems often require substantial hardware modifications, potentially altering the aesthetic and functional integrity of vintage or specialized machines. Additionally, such solutions typically involve expensive subscription services and complex computer systems that create new potential points of failure while requiring specialized training for operation and maintenance.

Non-invasive monitoring approaches, while preserving machine hardware integrity, can suffer from reliability issues in certain operational environments. Proximity-based magnetic sensors positioned adjacent to signal wires can be susceptible to false triggering from physical vibrations, machine movement during operation, or magnetic interference from adjacent machines in multi-machine installations. Such unreliability can result in inaccurate transaction counting, compromising the analytics data that operators rely upon for business intelligence and revenue tracking. Additionally, while proximity sensors avoid direct electrical connection, they may lack the signal integrity and noise immunity benefits achievable through direct electrical interfacing with existing standardized connector infrastructure increasingly found on modern payment-operated machines.

Existing retrofit solutions that employ mechanical relay systems face reliability challenges due to relay fatigue over extended operational cycles. Mechanical relays degrade over time through contact wear, resulting in inconsistent pulse generation that can cause transaction failures or miscounting. Competitor retrofit boards utilizing mechanical relays without optical isolation are particularly susceptible to electrical noise and voltage irregularities common in arcade and laundromat environments. The mechanical nature of these relay systems creates the very failure modes that operators seek to avoid when modernizing away from aging coin mechanism hardware. Additionally, some retrofit approaches rely on proximity sensing methods that, while avoiding direct electrical connection, suffer from false triggering due to vibration, machine movement, or electromagnetic interference from adjacent machines in multi-machine installations.

Modern coin mechanisms and bill acceptors increasingly incorporate standardized connector families, particularly JST connector types (JST-XH, JST-VH, JST-PH), as industry-standard interfaces for signal and power connections. These standardized connectors provide reliable electrical connections with defined pin configurations and contact specifications that ensure consistent signal integrity across varied environmental conditions. Retrofit solutions that leverage these existing standardized connector interfaces can achieve superior signal reliability compared to proximity-based sensing methods, while maintaining non-invasive installation characteristics through parallel tapping configurations that preserve original OEM wiring. Direct electrical interface monitoring through standardized connectors provides inherent noise immunity advantages over magnetic proximity sensors, which may be susceptible to false triggering from vibration, electromagnetic interference, or mechanical movement during machine operation.

Mechanical coin switches in legacy payment-operated machines develop predictable failure modes as they age, including micro-arcing between switch contacts, sticky contact surfaces due to oxidation or contamination, and contact bounce distortion that generates multiple false pulses from single coin insertion events. These degradation mechanisms result in revenue loss through miscounted transactions, machine downtime due to intermittent coin acceptance failures, and customer dissatisfaction from unpredictable machine operation. Replacement parts for vintage coin mechanisms are frequently unavailable or prohibitively expensive, creating operational challenges for businesses operating fleets of older payment-operated machines. Retrofit solutions that bypass dependence on mechanical switch integrity through alternative signal monitoring methods can extend the operational life of machines with degraded coin mechanisms while maintaining accurate transaction counting and analytics capabilities.

The management of distributed payment-operated machines presents significant operational challenges. The collection of physical currency from multiple machines across different locations requires substantial labor resources and time investment. This manual process becomes increasingly costly and inefficient as the number of machines and locations grows.

Current solutions for monitoring machine performance and collecting operational data are fragmented and often inadequate. Existing tools typically provide basic data in formats that are difficult to analyze, requiring additional training and resources to interpret. The lack of user-friendly analytics tools makes it challenging for operators to optimize their machine placement, maintenance schedules, and business strategies.

Furthermore, traditional payment systems lack the ability to effectively track and manage customer funds across multiple machines or locations. This limitation results in unused credits being effectively lost when stored on proprietary cards or tokens, creating customer dissatisfaction and reduced revenue potential.

These challenges highlight the need for a solution that can modernize payment-operated machines while preserving their original hardware integrity, streamline operational management, and provide business intelligence without requiring extensive modifications or ongoing subscription costs.

### SUMMARY OF THE INVENTION

The present invention provides a unified electronic control board (ECB) system for retrofitting existing payment-operated machines with multi-source transaction monitoring and direct-to-cloud analytics capabilities. The system enables concurrent monitoring of multiple payment input types—including plural coin mechanisms, bill acceptors, and ticket readers—while maintaining compatibility with legacy machine hardware through standardized connector interfaces and flexible power supply configurations.

The present invention in various embodiments thus provides a system and method for retrofitting existing coin-operated and bill-operated machines with electronic payment capabilities while maintaining original machine functionality. The system comprises a microcontroller-based payment module that interfaces with existing payment mechanism hardware through non-invasive installation methods.

In an embodiment, the system utilizes a unified ECB which comprises an ESP32-S3 microcontroller with integrated WiFi capabilities for direct cloud communication, three independent listener inputs configured to monitor transactions from dual coin slots and bill/ticket acceptors via standardized connector interfaces, three power supply input options providing installation flexibility across varied machine configurations, dual relay modules independently controlling coin listening and coin input functions, and LED diagnostic indicators providing visual confirmation of system voltage status.

The invention implements a machine-specific QR code payment interface that enables users to purchase and manage digital tokens through a web-based platform. Each machine is assigned a unique identifier encoded within its corresponding QR code, facilitating direct association between specific machines and payment transactions.

A key aspect of the invention is its ability to monitor both digital payments and traditional coin/bill operations through direct electrical interface monitoring via standardized JST connector parallel tapping. In alternative embodiments where direct electrical connection is impractical, the system may optionally incorporate a Hall effect sensor for non-invasive monitoring without requiring modification of existing payment mechanisms.

The system includes a cloud-based platform that manages payment processing, user authentication, and system analytics. The platform provides real-time monitoring of machine performance, revenue tracking, and maintenance requirements through a web-based dashboard interface.

The invention employs solid-state components throughout its design, eliminating mechanical points of failure while maintaining compatibility with existing coin mechanism standards. The system's modular architecture enables flexible deployment across various types of payment-operated machines, including arcade games, vending machines, and other coin-operated devices.

Security features include encrypted communication channels, secure token validation, and multiple layers of transaction verification.

### BRIEF DESCRIPTION OF THE FIGURES

FIG. 1 shows placement of a QR code on a coin operated machine and an interface of a mobile device capturing a photo of the QR code in accordance with a preferred embodiment.

FIG. 2 illustrates key system components in an embodiment configured as placed in the interior of a coin operated machine.

FIG. 3 presents a flowchart depicting the complete transaction flow for QR code payments, showing the sequence from user scanning through machine activation.

FIG. 4 displays circuitry as an internal system element in accordance with a preferred embodiment.

FIG. 5 depicts the detection elements associated with actuation of a coin operated machine in a preferred embodiment.

FIG. 6a shows a user interface displaying token purchase information, including token quantity, price per token, and total cost in accordance with an exemplary embodiment.

FIG. 6b illustrates a user interface comprising a transaction completion screen showing the final transaction amount and date in accordance with a preferred embodiment.

### DETAILED DESCRIPTION OF THE INVENTION

In accordance with an embodiment of the invention, a payment system is provided that enables retrofitting of existing coin-operated and bill-operated machines with a non-invasive electronic payment capability. The system comprises a microcontroller-based module that interfaces with existing payment mechanism hardware to enable digital payments with a smartphone via capturing a photograph of a QR code while preserving the machine's original functionality.

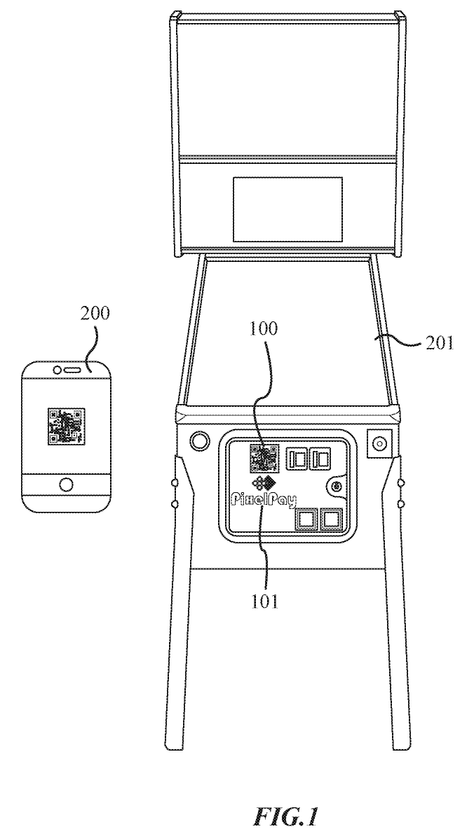

In accordance with FIG. 1, the system displays a payment-operated machine 201 equipped with a machine-specific QR code 100. The QR code 100 enables electronic payment processing while the coin operated device (optionally a pinball machine) 201 represents the payment-operated machine implementation. The mobile device 200 captures the QR code in an embodiment to facilitate payment in accordance with mechanisms widely understood in the art.

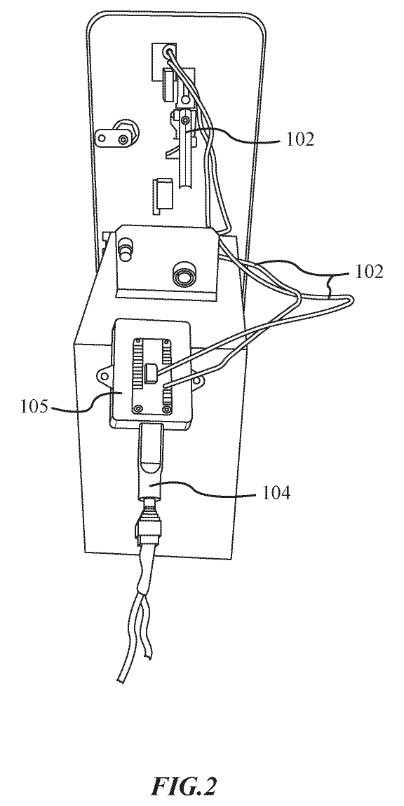

FIG. 2 illustrates the internal configuration of key system components, showing the coin mechanism and coin circuit 102, controller box 105, and power adapter 104. The controller box 105 houses the microcontroller assembly and in accordance with an embodiment is affixed to the interior of a coin operated device 201 via non-invasive mounting methods. The power adapter 104 in an embodiment connects through a standardized interface to provide consistent power delivery.

The system in accordance with an embodiment enables concurrent monitoring of multiple payment input types including: (1) a first coin mechanism or coin slot, (2) a second coin mechanism enabling dual-slot machine compatibility, and (3) a bill acceptor or ticket reader mechanism. This multi-source monitoring capability addresses the industry need for comprehensive analytics across all revenue streams while maintaining compatibility with varied machine configurations commonly found across arcade, laundry, and amusement device installations.

In accordance with an embodiment, the system provides direct compatibility with matrix-based pinball coin switch systems without requiring external harnesses or matrix adapter hardware. The unified ECB can interface directly with pinball coin switch matrix signals, enabling non-invasive retrofit installation on pinball machines while maintaining compatibility with the complex legacy signaling environments characteristic of matrix-based coin detection systems. This direct matrix signal compatibility eliminates the need for additional interface hardware or signal translation devices that competing retrofit solutions require when addressing pinball machine installations, providing a meaningful technical differentiator in the ability to support complex legacy signaling architectures while remaining non-invasive.

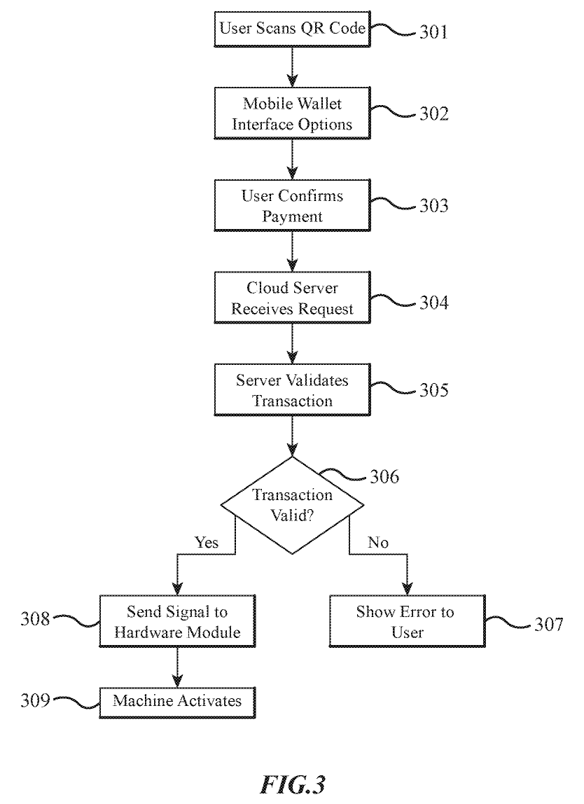

FIG. 3 presents the complete transaction flow in accordance with an exemplary embodiment for QR code payments. The process begins when a user scans the machine-specific QR code, which is designated as step 301. Following the scan, the mobile wallet interface automatically activates as step 302, presenting payment options to the user. The user then proceeds to confirm their payment in step 303, authorizing the transaction. Upon confirmation, the cloud server receives the payment request in step 304. The system then initiates transaction validation through steps 305-306, where the payment credentials and authorization are verified. If the transaction validation fails, error handling protocols designated as step 307 are activated to manage the failed transaction and notify the user. Upon successful validation, the system proceeds to step 308 where it transmits activation signals to the hardware module, which triggers the machine's operation 309.

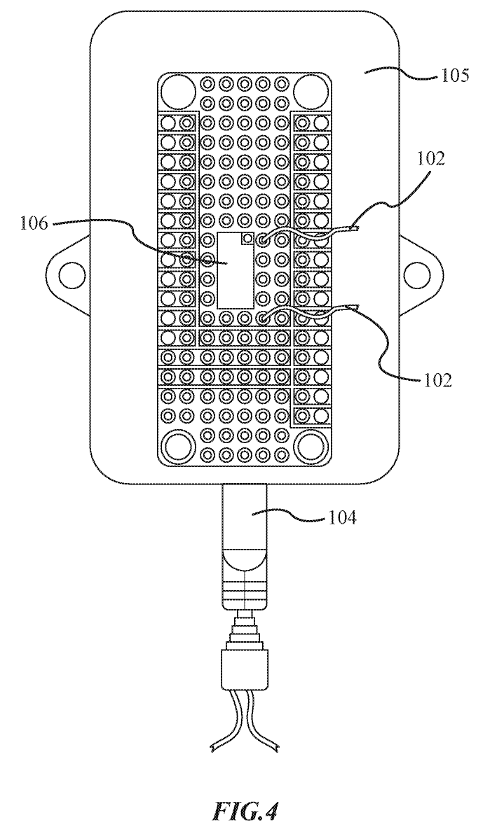

FIG. 4 depicts the internal circuitry layout in accordance with an embodiment, showing connections between the controller box 105, linkage to the coin mechanism coin circuit 102, half effect sensor 106, and power adapter 104. The configuration maintains signal integrity through strategic component placement and cable management.

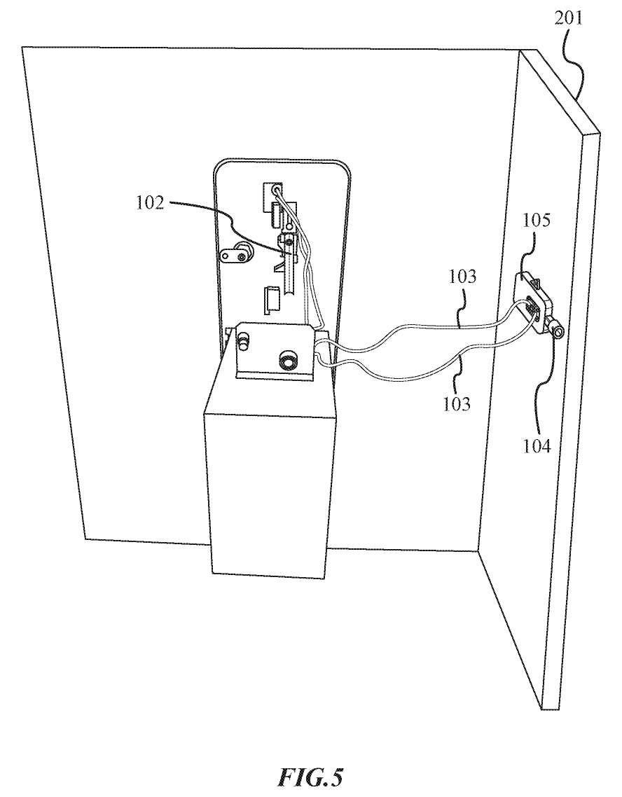

FIG. 5 illustrates the detection system architecture in accordance with an exemplary embodiment, showing the Hall effect sensor positioned relative to the coin operation mechanism 102, controller box 105, and power adapter 104. This arrangement enables non-invasive monitoring of payment operations.

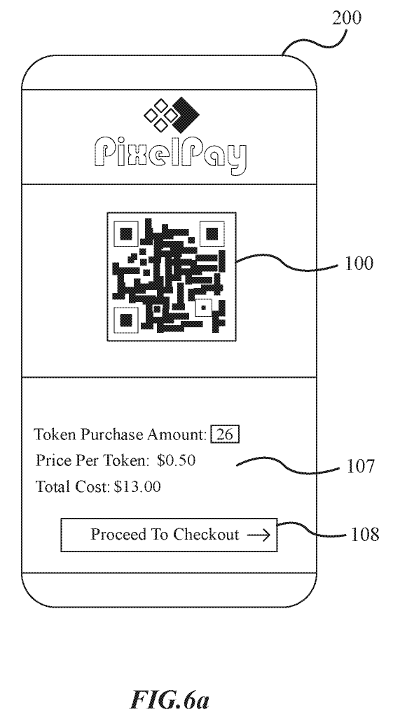

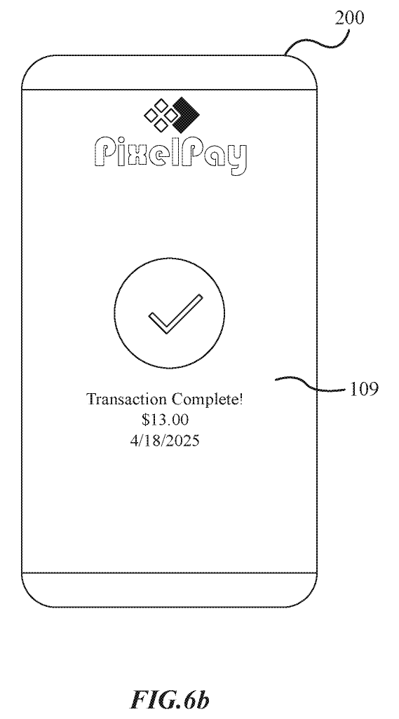

FIG. 6a displays the token purchase user interface in accordance with an exemplary embodiment showing coin information 107 including token quantity and pricing, with a checkout button 108 for transaction initiation. The interface presents token purchase amounts, individual pricing, and total cost calculations.

FIG. 6b shows the transaction completion screen in accordance with an exemplary embodiment with checkout information 109, displaying transaction amount and date confirmation. This interface provides immediate transaction verification to users.

In a preferred embodiment, the system comprises a unified electronic control board (ECB) implementing a multi-listener architecture with three independent transaction monitoring inputs, flexible power supply interfaces accommodating varied machine power configurations, dual-relay control systems, and integrated diagnostic indicators, all controlled by an ESP32-S3 microcontroller with direct-to-cloud WiFi communication capabilities.

The system incorporates standardized components including the QR code 100, logo 101, coin mechanism 102, coin circuit 103, power adapter 104, controller box 105, half effect sensor 106, coin information display 107, checkout button 108, checkout information 109, mobile device 200, and payment-operated machine 201. Each component maintains specific functionality while enabling seamless integration between traditional and digital payment systems.

In a preferred embodiment of the invention, the system includes an ESP32 S3 microcontroller with integrated wireless communication capabilities, an optocoupled relay system supporting multiple voltage configurations, and a Hall effect sensor for monitoring machine usage. The microcontroller assembly is designed to mount within existing machines without requiring significant modifications to the original hardware.

An example of the invention utilizes a machine-specific QR code system that interfaces with a web-based payment platform, allowing users to purchase and manage digital tokens through a mobile device or computer. The system leverages standardized communication protocols used by traditional coin mechanisms to seamlessly integrate digital payments with existing machine operations.

In an embodiment of the invention, the system includes an analytics platform that provides real-time monitoring of machine performance, revenue tracking, and maintenance requirements through a cloud-based dashboard. This platform collects data from both digital transactions and traditional coin/bill operations through the Hall effect sensor integration, providing operators with unified business intelligence capabilities.

The preferred embodiment of the invention employs solid-state components throughout its design, eliminating mechanical points of failure while maintaining compatibility with existing coin mechanism standards. The system's modular architecture allows for flexible deployment across various types of payment-operated machines, including arcade games, vending machines, and other coin-operated devices.

In a preferred embodiment of the invention, the microcontroller assembly comprises an ESP32-S3-MINI-1 module that integrates wireless communication capabilities including WiFi functionality for direct cloud communication. The module carries FCC ID: 2AC72-ESPS3MINI1 and IC: 21098-ESPS3MINI1 certifications for wireless operations.

The power system incorporates a standardized 5.5x21mm power input connection that interfaces with the machine's existing power supply. The microcontroller includes integrated power management through BAT EN input, USB interface, and dedicated power distribution terminals.

Communication interfaces comprise multiple data pins numbered 5-13, serial clock (SCL) interface, and RX/TX communication ports. The system employs encrypted communication protocols through its native wireless capabilities, with CE certification ensuring compliance with relevant standards.

The custom printed circuit board implementation features a Neo interface integration, reset circuitry placement, and boot configuration components positioned for optimal signal routing. The power distribution network incorporates DC power input connections, voltage regulation circuitry, and power supply routing to peripheral components.

Connection interfaces are arranged to provide data pin connections, serial communication ports, power distribution terminals, and peripheral device interfaces. The PCB assembly employs a compact form factor with secure mounting points and flexible wire routing options for non-invasive installation within existing machine enclosures.

The entire assembly maintains solid-state operation without mechanical components that could fail, while providing necessary interfaces for all required system functions. The power distribution system ensures stable voltage delivery across all components through integrated regulation and protection circuits.

In a preferred embodiment of the invention, the relay system incorporates a JQC3F-05VDC-C optocoupled relay module designed for integration with coin-operated mechanisms. The relay supports voltage ratings of 10A 250VAC/30VAC and 10A 125VAC/28VAC, providing flexible compatibility with various machine power configurations.

The relay module features high/low level trigger support and incorporates optical isolation for surge protection. The signal pulse generation system operates through a standardized interface that connects to the microcontroller's digital output pins, enabling precise control of pulse timing and duration.

Integration with the microcontroller is achieved through dedicated control terminals, including DC+ and DC- power connections, and an IN signal line for pulse control. The relay module includes LED status indication for visual confirmation of operation.

The machine interface employs a two-wire connection methodology that interfaces directly with existing coin mechanism circuitry. The connection points utilize NO (Normally Open), COM (Common), and NC (Normally Closed) terminals to provide flexible integration options with various machine configurations.

The pulse signal specifications match industry-standard coin mechanism protocols, generating electrical pulses that replicate the signals produced by traditional coin acceptance events. This standardization ensures compatibility with existing machine control systems without requiring modification of the base hardware.

Power supply connections are managed through the relay module's integrated power distribution system, which accepts machine power and provides regulated output to ensure consistent operation. The power interface includes protection circuitry to prevent voltage spikes and maintain signal integrity across the connection points.

In a preferred embodiment of the invention, the Hall effect sensor system utilizes a 20A ZZY-MH series magnetic sensor for detecting and monitoring coin mechanism pulses.

The magnetic resistance sensing capabilities enable non-invasive monitoring of coin mechanism signals through detection of magnetic field changes generated by current flow in the signal wires. The sensor's calibration methodology involves positioning the sensor in close proximity to the coin mechanism's signal wires to achieve optimal detection sensitivity.

Signal detection parameters are configured to recognize standardized pulse patterns generated by coin acceptance events. The system processes these signals through the microcontroller's analog input channels, converting magnetic field variations into digital signals for transaction tracking.

The installation configuration employs a specific wire placement methodology where the Hall effect sensor is positioned adjacent to, but not directly connected to, the coin mechanism's signal wires. This non-invasive approach maintains the original functionality of the payment system while enabling parallel monitoring of transactions.

The signal monitoring setup incorporates dedicated analog input channels on the microcontroller for processing the Hall effect sensor's output. The system includes signal conditioning circuitry to ensure reliable pulse detection across various machine configurations and environmental conditions.

Pulse detection thresholds are calibrated specifically for each installation to account for variations in coin mechanism designs and signal characteristics. The calibration process ensures accurate detection of legitimate coin acceptance events while filtering out electromagnetic noise and other potential interference sources.

In a preferred embodiment of the invention, the QR code system implements machine-specific code generation through a cloud-based platform. Each machine is assigned a unique identifier that is encoded within its corresponding QR code, enabling direct association between specific machines and payment transactions.

The system generates secure QR codes that incorporate encryption parameters and authentication tokens. These security measures ensure that only authorized transactions can be processed through the system's payment gateway. The QR codes are dynamically updated based on machine status and operational parameters.

The scanner interface is implemented through a web-based application that enables users to scan machine-specific QR codes using their mobile devices. The web application provides a streamlined interface for users to initiate and complete payment transactions.

Authentication protocols are integrated into the scanning process, verifying both the machine identity and user authorization status. The system implements secure token validation to ensure transaction integrity throughout the payment process.

The payment processing flow begins when a user scans the machine-specific QR code. The web application presents options for token purchase and payment processing through integrated payment gateways. Upon successful payment verification, the system transmits authorization signals to the machine's control module.

The web interface allows users to manage their account credits and initiate machine activation through a standardized token system. Each token represents a predetermined value ($0.25) that can be applied across any compatible machine in the network.

In a preferred embodiment of the invention, the cloud platform implements a distributed server architecture that manages communication between mobile devices, payment modules, and system servers. The server system includes dedicated API endpoints for device authentication, payment processing, and analytics data collection.

The security protocols incorporate encrypted communication channels between system components, with authentication requirements for all API interactions. The server validates transaction requests through the mobile device's long-range communication capability before authorizing payment module operations.

In a preferred embodiment, the system implements a unified database architecture that consolidates machine-specific information, transaction records, usage analytics, authorization information, operational metrics and maintenance status data within a single secure cloud database structure. The system maintains data organization and relationships through table schemas and data models while enabling efficient querying and analysis across all operational aspects from a centralized database. This consolidated approach streamlines data management while preserving the ability to track and analyze distinct categories of operational data. Data storage structures are implemented to maintain machine-specific information, transaction records, and usage analytics. In an alternative embodiment, the system stores authorization information and transaction data while maintaining or otherwise interacting with separate databases for operational metrics and maintenance status tracking.

In a preferred embodiment of the invention, the QR code-based token system implements a secure transaction architecture where each machine-specific QR code contains an encrypted unique identifier. When a user scans the QR code through the web-based platform, the system validates and deducts pre-existing tokens from the user's account balance stored in the secure cloud database. The tokens represent predetermined monetary values (e.g. $0.25) and are associated with user accounts rather than specific machines. Transaction validation occurs through real-time API calls between the ESP32-S3 microcontroller module installed in the machine and the cloud platform, eliminating the need for local token storage.

The Hall effect sensor monitoring system in an embodiment implements non-invasive transaction verification through magnetic field detection. The sensor is precisely calibrated to detect magnetic field variations generated by current flow in the coin mechanism's signal wires without requiring physical connection to the circuitry. The system employs the ZZY-MH series magnetic sensor positioned adjacent to, but not in contact with, the signal wires. This configuration enables parallel monitoring of both traditional coin operations and digital payment events while maintaining the original machine's mechanical integrity.

The cloud-direct communication implementation in accordance with an exemplary embodiment utilizes the ESP32-S3 microcontroller's integrated WiFi capabilities to establish secure, direct connections with the cloud platform. The system implements encrypted API endpoints for device authentication, payment processing, and transaction validation without requiring intermediary devices. The communication architecture includes automated failover protocols and continuous connection monitoring to ensure reliable operation. Real-time synchronization between the payment module and cloud platform enables immediate transaction processing and verification while maintaining detailed audit trails of all payment events.

The token system implementation standardizes payments across all compatible machines through a digital credit system. Each token represents a fixed value of $0.25, enabling consistent pricing across different machine types. The system manages token allocation and redemption through secure transaction protocols.

Credit management functions handle user account balances, token purchases, and transaction history. The platform maintains real-time synchronization of credit balances across multiple devices and locations, enabling seamless credit utilization across any compatible machine in the network.

Transaction processing occurs through a multi-step verification system that includes initial authorization, payment validation, and completion confirmation. The system processes payment requests through integrated payment gateways, manages token distribution, and provides transaction confirmation through the mobile interface.

In a preferred embodiment of the invention, the analytics dashboard implements data collection functionality through integration with both the payment module and Hall effect sensor systems. The system tracks usage metrics which in various embodiments include those like machine activation frequency, duration of use, and payment method distribution across traditional coin operations and digital payments.

Revenue tracking capabilities provide real-time monitoring of transaction values, with separate tracking for coin-operated transactions detected through the Hall effect sensor and digital payments processed through the QR code system. The platform generates performance analytics by analyzing usage patterns, peak operating periods, and machine-specific revenue trends.

The system continuously monitors maintenance indicators through automated detection of irregular operation patterns, payment processing anomalies, and machine response characteristics. These indicators enable proactive maintenance scheduling and rapid response to potential system issues.

The user interface implements a web-based dashboard that presents operational data through an intuitive layout. The interface displays machine status, transaction history, and performance metrics through organized sections that enable efficient monitoring of multiple machines.

Reporting features include customizable data visualization tools that present usage statistics, revenue analysis, and maintenance status information. The system generates automated reports for business intelligence purposes, enabling operators to optimize machine placement and operational strategies.

The alert system provides real-time notifications for significant events including maintenance requirements, unusual activity patterns, and system status changes. These alerts are delivered through both the dashboard interface and configurable notification channels.

Management tools in accordance with an embodiment enable operators to configure machine-specific parameters including pricing structures, promotional credits, and operational schedules, manage user access permissions at individual or group levels, and implement operational policies across single machines or entire multi-location fleets. The system includes remote management capabilities for updating machine configurations and monitoring system health status in real-time. In an exemplary embodiment in accordance with the invention, the unified ECB implements three isolated listener inputs using JST-XH parallel taps for simultaneous monitoring of two coin channels and one bill/ticket acceptor without modifying existing machine circuitry. This multi-source listening architecture in accordance with the invention enables comprehensive revenue tracking across all payment input types, including dual coin slot configurations common in higher-denomination arcade games and laundry machines, plus bill acceptor or ticket reader mechanisms. Each of the three listener inputs operates as an electrically isolated monitoring channel with dedicated signal conditioning circuitry, ensuring that transaction events from different payment mechanisms are detected independently without cross-talk or signal interference. The JST-XH parallel tap configuration preserves the original functionality and wiring integrity of legacy payment mechanisms while enabling real-time digital transaction monitoring and cloud-based analytics across all physical payment channels.

The management platform in an embodiment receives and processes transaction data from all configured listener inputs, providing operators with unified reporting across multiple payment input types. The system distinguishes transaction sources based on listener input origin, enabling detailed analytics including: (a) dual coin slot performance comparison, (b) bill acceptor vs. coin mechanism utilization ratios, (c) ticket redemption tracking and digital account integration, and (d) cross-platform revenue analysis for varied machine configurations.

In a preferred embodiment of the invention, the physical installation system employs non-invasive mounting methods that preserve the integrity of the existing machine hardware. The installation utilizes velcro attachments to secure the microcontroller assembly within the machine enclosure, enabling easy access for maintenance while maintaining a secure connection.

Wire routing specifications detail the path of power and signal connections through existing wire channels in the machine. The system implements a standardized wiring methodology that connects to the machine's power supply through a 5.5x21mm power input interface while maintaining separation between signal and power cables to prevent interference.

The unified ECB configuration in accordance with an exemplary embodiment implements three independent listener input channels: (1) first coin mechanism monitoring via JST-XH parallel tap connector interface configured to detect transaction pulses from a primary coin slot, (2) second coin mechanism monitoring for dual-slot machine compatibility via JST-XH parallel tap connector interface configured to detect transaction pulses from a secondary coin slot, and (3) bill/ticket acceptor monitoring via JST-XH parallel tap connector interface configured to detect transaction signals from bill acceptors or ticket reader mechanisms. Each input channel maintains electrical isolation while enabling concurrent transaction detection across all monitored payment sources. The JST-XH connector specification provides standardized interface compatibility with modern coin mechanisms and bill acceptors that increasingly incorporate JST connector families as industry-standard connection interfaces.

The power connection methodology incorporates direct integration with the machine's existing power supply system. The power distribution includes surge protection and voltage regulation to ensure stable operation across various machine power configurations.

In the primary embodiment in accordance with the invention, the system interfaces with payment mechanism signal outputs through standardized electrical connections utilizing JST-XH connectors for parallel tapping. The JST-XH connectors attach to coin mechanisms and bill acceptors by tapping into existing JST connector ports present on modern payment mechanisms, or by utilizing Y-split adapter cables that enable parallel signal monitoring without interrupting the original signal path between the payment mechanism and the machine's control circuitry. The parallel configuration ensures that transaction signals are simultaneously available to both the legacy machine control system and the unified ECB monitoring system without signal degradation or processing delays. This non-invasive JST-based installation methodology preserves the integrity of OEM wiring while enabling comprehensive multi-source transaction monitoring with superior signal reliability and noise immunity compared to proximity-based sensing methods.

In alternative embodiments where direct JST connector access is unavailable or impractical due to machine-specific design constraints, Hall effect sensor placement may be employed as an optional enhancement. The sensor requires precise positioning adjacent to the coin mechanism's signal wires to detect magnetic field variations without requiring direct electrical connection to the existing circuitry.

Signal wire integration for the Hall effect sensor maintains non-invasive monitoring capabilities through careful positioning of the sensor relative to the coin mechanism's signal paths. This configuration enables detection of both digital payment signals and traditional coin operation pulses.

The calibration procedures involve adjusting the Hall effect sensor's sensitivity to match the specific characteristics of the host machine's coin mechanism. The process includes verification of pulse detection thresholds and confirmation of reliable signal monitoring across various operating conditions.

In a preferred embodiment of the invention, the network setup implements WiFi configuration through the ESP32-S3 microcontroller's integrated wireless capabilities. The system utilizes the microcontroller's certified wireless communication protocols to establish secure connections with the cloud platform.

Security protocols incorporate encrypted communication channels between system components, with authentication requirements for all network interactions. The system implements multiple layers of security validation for transaction processing and device authentication.

Machine-specific settings include precise pulse timing calibration that matches the timing characteristics of traditional coin mechanism signals. The calibration process ensures compatibility with existing machine control systems while maintaining accurate transaction processing.

The payment verification system implements a multi-step validation process that includes initial authorization through the cloud platform, followed by local verification at the payment module. The system confirms successful transaction completion before triggering machine activation.

Error handling protocols monitor system operation and implement automated responses to various error conditions. The system includes detection and handling of communication failures, payment processing errors, and hardware malfunctions. Upon detecting an error condition, the system executes appropriate recovery procedures while maintaining secure operation.

In a preferred embodiment of the invention, the hardware security system implements physical access protection through strategic mounting and enclosure design. The system utilizes secure mounting methods that prevent unauthorized access while maintaining serviceability for authorized maintenance. Component protection is achieved through careful placement within the machine enclosure, utilizing existing security features of the host machine.

The communication security architecture implements encryption protocols through the ESP32-S3 microcontroller's certified wireless systems. The module includes FCC ID: 2AC72-ESPS3MINI1 and IC: 21098-ESPS3MINI1 certifications, ensuring compliance with security standards for wireless communication.

The secure boot process validates system integrity during startup through the ESP32-S3's integrated security features. The boot sequence includes verification of firmware authenticity and integrity checks of critical system components.

Authentication methods incorporate multiple validation layers for both device and transaction security. The system implements secure token validation for payment processing and device authentication through the cloud platform. Communication between system components occurs through encrypted channels with required authentication for all interactions.

The security implementation includes CE certification compliance, ensuring adherence to relevant security standards for electronic payment systems. The system maintains secure operation through continuous monitoring of communication channels and system status.

In a preferred embodiment of the invention, the payment processing security system implements transaction verification through a multi-stage validation process. The system validates transaction requests through secure communication between the mobile device and payment module before authorizing machine activation.

Token validation occurs through a secure authorization process where the system verifies the authenticity of digital tokens before processing transactions. The validation includes verification of token ownership and availability of sufficient credits in the user's account.

Error handling for payment processing incorporates automated detection and response protocols for transaction failures, communication interruptions, and validation errors. The system maintains transaction integrity by implementing rollback procedures for incomplete transactions while ensuring accurate credit management.

The data protection system implements encryption standards that secure all communication channels between system components. The encryption protocols protect transaction data, user information, and system configuration details through standardized security protocols supported by the ESP32-S3 microcontroller.

Access controls are implemented through a hierarchical permission system that manages user authentication and authorization levels. The system controls access to administrative functions, payment processing, and system configuration options through secure authentication protocols.

The backup system maintains redundant storage of critical data including transaction records, user account information, and system configuration settings. The platform implements automated backup procedures with secure storage protocols to ensure data integrity and availability.

In a preferred embodiment of the invention, the hardware monitoring system implements component status tracking through continuous monitoring of critical system elements. The system tracks the operational status of the microcontroller, relay module, and Hall effect sensor through integrated diagnostic protocols.

Error detection capabilities monitor signal integrity across system components, including pulse detection accuracy, relay operation, and communication channel stability. The system implements automated detection of irregular operation patterns and component malfunctions.

Performance metrics tracking includes monitoring of transaction processing times, communication latency, and system response characteristics. The system maintains operational statistics for both digital payment processing and traditional coin mechanism operations through the Hall effect sensor integration.

The software monitoring system implements automated health checks that verify system integrity and operational status. These checks include validation of communication channels, payment processing systems, and data synchronization status.

Update management functionality enables secure deployment of software updates across system components. The system maintains version control and update verification while ensuring continuous operation during update processes.

Error logging capabilities maintain detailed records of system events, including transaction processing errors, communication failures, and component status changes. The logging system implements secure storage of error data with timestamp information and event categorization to facilitate troubleshooting and maintenance.

In a preferred embodiment of the invention, the routine maintenance procedures include calibration of the Hall effect sensor to maintain optimal pulse detection sensitivity. The calibration process involves adjusting sensor positioning and threshold settings to match specific coin mechanism characteristics.

Component testing procedures verify proper operation of the microcontroller, relay module, and Hall effect sensor systems. The testing includes verification of pulse generation, signal detection, and communication channel functionality through automated diagnostic routines.

Software update procedures are managed through the system's secure communication channels, enabling remote deployment of firmware and configuration updates. The update process includes verification of update integrity and automated rollback capabilities in case of update failures.

The troubleshooting system in accordance with an embodiment addresses common issues including communication interruptions, payment processing errors, and component malfunctions, and implements automated error detection providing diagnostic information through the cloud dashboard interface. The unified ECB power configuration in accordance with an exemplary embodiment comprises 12V DC input via barrel jack, plus two JST power options (XH and VH families) to support the most common retrofit environments. Specifically, the power input interface includes: (a) a standardized 5.5×2.1mm barrel connector accepting 12V DC input commonly used in consumer electronics and arcade machine power supplies, (b) a JST-XH connector type configured for 12V DC power input matching the connector family used for signal listener taps, and (c) a JST-VH connector type configured for 12V DC power input providing higher current capacity for installations requiring robust power delivery. This tri-modal power input architecture in accordance with the invention enables installation flexibility across varied machine configurations, power supply types, and available connection interfaces without requiring modification of existing power supply systems, while integrated voltage regulation circuitry ensures stable 3.3V and 5V rail voltages for microcontroller and relay operation regardless of selected power interface.

Resolution procedures in accordance with an embodiment are documented for various error conditions, with step-by-step guidance for addressing common installation and operational issues. The procedures include verification steps to confirm successful resolution and system restoration. In an exemplary embodiment in accordance with the invention, the system implements parallel signal detection via JST-XH leads tied into the machine's existing coin and bill acceptor outputs. The ECB listens in parallel without interrupting or replacing OEM wiring. This parallel tap configuration in accordance with the invention ensures that transaction signals generated by physical coin or bill insertion are simultaneously available to both the legacy machine control system and the unified ECB monitoring system. The high-impedance listener inputs draw negligible current from the monitored signal lines, ensuring no signal degradation, voltage drop, or processing delays that could affect operation of the legacy machine control circuitry. The parallel interface methodology enables comprehensive transaction monitoring and analytics while maintaining full backward compatibility with the machine's original cash-based payment functionality.

Support protocols in accordance with various embodiments establish standardized procedures for maintenance personnel to diagnose and resolve system issues, including remote diagnostic capabilities and escalation procedures for complex technical matters requiring engineering support. When the cloud platform authorizes a digital payment transaction, the unified ECB generates a coin acceptance signal to the legacy machine control system through relay-driven pulse injection matching OEM coin pulse width, voltage, and rise/fall characteristics regardless of machine age or mechanical condition. In an exemplary embodiment, the microcontroller analyzes the pulse characteristics of actual mechanical coin insertions detected through the listener inputs during a calibration phase, then replicates these exact electrical characteristics when generating simulated coin pulses via the optocoupled relay output. This precise pulse generation in accordance with the invention ensures compatibility with legacy machine control systems by simulating flawless mechanical coin acceptance events, effectively bypassing any degradation or failure modes present in aging physical coin switches such as contact bounce, micro-arcing, or sticky contacts.

In a preferred embodiment of the invention, the payment processing method implements a direct cloud-based validation system that eliminates the need for mobile device intermediation. When a user scans a machine-specific QR code, the system initiates a secure API connection between the ESP32-S3 microcontroller and the cloud platform through its integrated WiFi capabilities. The QR code contains an encrypted unique identifier that allows the cloud platform to associate the transaction request with the specific machine.

The validation process in accordance with a primary embodiment occurs through real-time API calls between the payment module and cloud platform, where the cloud platform verifies available funds and authorization status. Upon successful validation, the cloud platform transmits an encrypted authorization signal directly to the ESP32-S3 module via its WiFi connection, eliminating multi-hop routing through mobile devices and reducing transaction latency. In embodiments where direct parallel tapping of coin mechanism signal wires via JST connectors is the primary monitoring method, the system achieves superior signal integrity and noise immunity. In alternative embodiments where JST-based parallel tapping is impractical due to machine-specific design constraints, space limitations, or operator preference to avoid any electrical connection to existing circuitry, a Hall effect sensor may be mounted adjacent to the coin signal wire for non-invasive magnetic detection. The Hall effect sensor in accordance with this alternative embodiment utilizes magnetic field detection to monitor current flow in the coin mechanism signal wires without requiring any physical electrical connection, enabling transaction monitoring while preserving complete electrical isolation from the machine's original wiring harness.

Upon receiving cloud authorization, the system activates the optocoupled relay module through a standardized interface that connects to the microcontroller's digital output pins. The relay module, incorporating a JQC3F-05VDC-C optocoupled relay, generates electrical pulses that replicate the signals produced by traditional coin acceptance events. The pulse signal specifications match industry-standard coin mechanism protocols to ensure compatibility with existing machine control systems.

In an embodiment in accordance with the invention, the unified ECB incorporates LED indicator elements providing visual diagnostic feedback regarding system power status and operational readiness. Voltage-status LEDs indicate 12V input presence and microcontroller power-on state to simplify installation troubleshooting. In a preferred embodiment, a first LED element illuminates when 12V DC power is successfully supplied through any of the power input interfaces (barrel jack, JST-XH, or JST-VH), providing immediate visual confirmation of proper power connection. A second LED element illuminates when the ESP32-S3 microcontroller has completed boot sequence initialization and entered operational mode, confirming that the system is ready to detect and process payment transactions. This dual-LED diagnostic configuration enables installation technicians to verify proper system operation without requiring external voltage meters or specialized diagnostic equipment, significantly reducing installation time and troubleshooting complexity in field deployment scenarios. In an exemplary embodiment, a Hall effect sensor utilizing a 20A ZZY-MH series magnetic sensor is positioned adjacent to the coin signal wire for non-invasive magnetic detection where direct parallel tapping is impractical. The sensor detects magnetic field variations generated by current flow in the signal wires, enabling transaction monitoring without requiring any physical connection to the machine's existing circuitry.

Transaction completion monitoring occurs through the Hall effect sensor system, which utilizes a 20A ZZY-MH series magnetic sensor positioned adjacent to the coin mechanism's signal wires. The sensor detects magnetic field variations generated by current flow during both digital payment activations and traditional coin operations, enabling comprehensive transaction verification without requiring modification of existing circuitry. The system processes these signals through the microcontroller's analog input channels, converting magnetic field variations into digital signals for transaction tracking and verification.

In accordance with an embodiment the invention, the unified ECB implements direct signal interface monitoring through three independent listener inputs configured to accept standardized connector interfaces. Each listener input comprises positive and negative signal lines interfacing directly with corresponding outputs from respective payment mechanisms via JST-XH connectors as the primary standardized interface method. In alternative embodiments, the system may accommodate JST-PH, JST-VH, or paddle connector configurations depending on the specific payment mechanism manufacturer and available connection points on the legacy machine hardware. The listener circuits operate in parallel with existing machine control circuitry, enabling simultaneous signal detection by both legacy systems and the monitoring ECB without interrupting or replacing OEM wiring.

The system and method described herein can be advantageously applied to various other types of payment-accepting units beyond arcade machines in accordance with embodiments. For example, the system can be implemented in car washes in an embodiment, where each wash bay or automatic wash tunnel is equipped with a unique QR code. Upon scanning the QR code with their mobile device, users can select and purchase different wash packages or options through the web-based platform. The ESP32-S3 microcontroller assembly interfaces with the car wash's existing payment control system through the optocoupled relay module to activate the selected wash cycle.

In accordance with an exemplary embodiment, the unified ECB incorporates three distinct power supply input interfaces: (a) a standardized 5.5x21mm barrel connector accepting 12V DC input, (b) a first JST-XH connector type configured for 12V DC power input, and (c) a second JST-VH connector type configured for 12V DC power input. Each power input accepts 12V DC with integrated voltage regulation ensuring stable operation regardless of selected power interface. This tri-modal power configuration in accordance with the invention enables installation flexibility to support the most common retrofit environments and machine power configurations without requiring power supply modifications.

For an embodiment implemented in association with laundromat applications, each washer and dryer can be retrofitted with the payment module and assigned a unique machine-specific QR code. Users can purchase wash and dry cycles by scanning the QR code and selecting the desired cycle options through their mobile device. The system's Hall effect sensor monitors both digital payment activations and traditional coin operations, enabling comprehensive transaction tracking for laundromat operators while maintaining the original coin acceptance functionality.

The unified ECB in accordance with an embodiment employs a dual-relay configuration providing independent control of monitoring and actuation functions. A first relay module comprising a JQC3F-05VDC-C optocoupled relay with voltage ratings of 10A 250VAC/30VAC and 10A 125VAC/28VAC is coupled to the listener circuits and provides power management for transaction monitoring functions. A second relay module, also comprising a JQC3F-05VDC-C optocoupled relay, is coupled to the coin input circuit and generates coin pulse simulation signals upon receiving payment authorization from the cloud platform. The optocoupled design provides surge protection and electrical isolation, ensuring stable, repeatable coin pulses without mechanical degradation over time.

For an embodiment implemented in association with vending machines, the system enables contactless purchases of products through the same QR code-based interface. The machine-specific QR code contains an encrypted unique identifier that allows the cloud platform to associate the transaction request with the specific vending machine. Upon successful payment validation through the cloud platform, the ESP32-S3 module activates the optocoupled relay to trigger the vending machine's dispensing mechanism. The Hall effect sensor system provides transaction verification by detecting the magnetic field variations generated during both digital payment activations and traditional coin operations.

When the bill/ticket listener input detects a transaction signal from a bill acceptor or ticket reader mechanism in accordance with an embodiment, the microcontroller is configured to process the parallel-tapped signal through the third isolated JST-XH listener channel. The system identifies transaction values based on pulse patterns or serial data protocols specific to the bill/ticket acceptor model, extracts denomination information, and uploads the transaction data to the cloud platform in real-time for unified revenue tracking. The system enables digital tracking of physical ticket-based transactions and unified account management across both cash-based and cashless payment modalities while maintaining the machine's original bill/ticket processing functionality.

The non-invasive installation methodology remains consistent across these applications in accordance with a preferred embodiment, utilizing the standardized 5.5x21mm power input interface and velcro mounting system to preserve the integrity of the existing machine hardware. The system's modular architecture enables flexible deployment across these various types of payment-accepting units while maintaining compatibility with their existing payment mechanism standards.

The unified ECB in accordance with an embodiment of the invention incorporates LED indicator elements providing visual diagnostic feedback regarding system voltage status. The LED indicators are configured to illuminate in response to 12V input presence and microcontroller power-on state, providing immediate visual confirmation of proper power supply connection during installation and enabling rapid troubleshooting without external test equipment. In a preferred embodiment, voltage-status LEDs indicate 12V input presence and microcontroller power-on state to simplify installation troubleshooting.

In accordance with various embodiments of the invention described herein, a payment system is provided that enables retrofitting of existing coin-operated and bill-operated machines with electronic payment capabilities while maintaining original machine functionality. The system comprises a microcontroller-based module with wireless communication capabilities, an optocoupled relay system, and a Hall effect sensor that together enable digital payments while preserving existing payment mechanisms.

The system in a preferred embodiment thus implements a machine-specific QR code payment interface that connects to a cloud-based platform for processing transactions and managing digital tokens. This platform provides analytics and management capabilities through a web-based dashboard interface that enables monitoring of both digital and traditional payment operations.

In alternative embodiments, the system implements a unified electronic control board (ECB) configuration comprising multiple independent listener inputs for concurrent monitoring of plural payment input sources, including dual coin mechanisms and bill/ticket acceptors, with flexible power supply options and dual-relay control architecture.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Alternative embodiments may employ different transaction monitoring approaches, including direct connector-based signal interfaces using standardized JST or paddle connectors, depending on the specific payment mechanism manufacturer and available connection points on the legacy machine hardware.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments.

It will be appreciated that the monitoring functionality described herein may be implemented through various sensor configurations and interface methodologies, including direct signal interfaces, proximity-based sensing, or hybrid approaches, depending on specific machine requirements, installation constraints, and signal reliability priorities.

The present invention has been described in sufficient detail with a certain degree of particularity. It is understood that the present disclosure of embodiments has been made by way of examples and that numerous changes in the arrangement and combination of parts may be resorted without departing from the spirit and scope of the invention as claimed.

What is claimed is:

1. A system for retrofitting payment-operated machines, comprising:
a unified electronic control board (ECB) comprising a microcontroller assembly comprising an ESP32-S3 microcontroller with integrated WiFi capabilities for direct communication with a cloud platform,
three isolated listener inputs configured for simultaneous monitoring of two coin channels and one bill/ticket acceptor via standardized connector interfaces without modifying existing machine circuitry,
a power input interface comprising multiple distinct power supply connection options, a dual relay module comprising optocoupled relays independently controlling monitoring and actuation functions, and LED diagnostic indicators configured to provide visual feedback regarding system voltage status;
a machine-specific QR code payment interface;
a cloud-based payment processing platform configured to communicate directly with the microcontroller assembly via WiFi; and
a web-based analytics dashboard;
wherein the system is configured to enable electronic payments through direct cloud-based validation while maintaining original machine functionality.

2. The system of claim 1, wherein the three isolated listener inputs comprise JST-XH parallel tap connector interfaces, each listener input configured to interface directly with corresponding outputs from respective payment mechanisms, operate in parallel with existing machine control circuitry, and enable simultaneous signal detection by both legacy machine systems and the unified ECB without interrupting or replacing OEM wiring.

3. The system of claim 2, wherein the JST-XH parallel tap connector interfaces implement parallel signal detection via JST-XH leads tied into the machine's existing coin and bill acceptor outputs, and wherein transaction signals generated by physical coin or bill insertion are simultaneously available to both legacy machine control systems and the unified ECB monitoring system.

4. The system of claim 2, wherein the three isolated listener inputs comprise high-impedance listener inputs that draw negligible current from monitored signal lines, ensuring no signal degradation, voltage drop, or processing delays that affect operation of legacy machine control circuitry.

5. The system of claim 2, wherein a first listener input is configured to monitor transaction pulses from a primary coin slot via JST-XH parallel tap connector interface, a second listener input is configured to monitor transaction pulses from a secondary coin slot via JST-XH parallel tap connector interface, and a third listener input is configured to monitor transaction signals from bill acceptors or ticket reader mechanisms via JST-XH parallel tap connector interface, and wherein each input channel maintains electrical isolation while enabling concurrent transaction detection across all monitored payment sources.

6. The system of claim 1, wherein the power input interface comprises three distinct power supply input options including a standardized 5.5×2.1mm barrel connector accepting 12V DC input, a first JST-XH connector type configured for 12V DC power input, and a second JST-VH connector type configured for 12V DC power input, and wherein integrated voltage regulation circuitry ensures stable 3.3V and 5V rail voltages for microcontroller and relay operation regardless of selected power interface.

7. The system of claim 1, wherein the dual relay module comprises a first relay module comprising a JQC3F-05VDC-C optocoupled relay with voltage ratings of 10A 250VAC/30VAC and 10A 125VAC/28VAC coupled to the listener circuits for power management of transaction monitoring functions and a second relay module comprising a JQC3F-05VDC-C optocoupled relay coupled to a coin input circuit for generating coin pulse simulation signals upon receiving payment authorization from the cloud platform, and wherein the optocoupled design provides surge protection and electrical isolation ensuring stable, repeatable coin pulses without mechanical degradation over time.

8. The system of claim 7, wherein when the cloud platform authorizes a digital payment transaction, the unified ECB generates a coin acceptance signal to a legacy machine control system through relay-driven pulse injection matching OEM coin pulse width, voltage, and rise/fall characteristics regardless of machine age or mechanical condition, and wherein the microcontroller is configured to analyze pulse characteristics of actual mechanical coin insertions detected through the listener inputs during a calibration phase and replicate exact electrical characteristics when generating simulated coin pulses via optocoupled relay output to ensure compatibility with legacy machine control systems.

9. The system of claim 2, wherein the unified ECB is configured to interface directly with matrix-based pinball coin switch systems, enabling the JST-XH parallel tap connector interfaces to monitor matrix signal outputs from pinball coin switch mechanisms without requiring external harnesses or matrix adapter hardware, and wherein the system maintains compatibility with complex legacy signaling environments characteristic of matrix-based coin detection systems while preserving non-invasive installation methodology.

10. The system of claim 1, wherein the LED diagnostic indicators comprise voltage-status LEDs configured to indicate 12V input presence when 12V DC power is successfully supplied through any power input interface and indicate microcontroller power-on state when the ESP32-S3 microcontroller has completed boot sequence initialization and entered operational mode, and wherein the LED indicators simplify installation troubleshooting without requiring external voltage meters or specialized diagnostic equipment.

11. The system of claim 1, further comprising a Hall effect sensor utilizing a magnetic sensor positioned adjacent to a coin signal wire for non-invasive magnetic detection where direct parallel tapping is impractical, and wherein the Hall effect sensor utilizes magnetic field detection to monitor current flow in coin mechanism signal wires without requiring physical electrical connection.

12. The system of claim 1, wherein the cloud-based payment processing platform is configured to receive payment requests directly from user mobile devices via phone-to-cloud communication, transmit encrypted authorization signals directly to the ESP32-S3 microcontroller via WiFi connection without routing through the mobile device as an intermediary, and eliminate multi-hop routing pathways that route payment authorization through mobile devices to payment modules.

13. The system of claim 5, wherein when the third listener input detects a transaction signal from a bill acceptor or ticket reader mechanism, the microcontroller is configured to process the parallel-tapped signal through the third isolated JST-XH listener channel, identify transaction values based on pulse patterns or serial data protocols specific to the bill/ticket acceptor model, and upload transaction data to the cloud platform in real-time for unified revenue tracking.

14. A method for processing payments on retrofitted payment-operated machines, comprising:
monitoring transaction signals from two coin channels and one bill/ticket acceptor simultaneously through three isolated listener inputs using JST-XH parallel taps without modifying existing machine circuitry;
receiving a QR code scan from a mobile device at a cloud platform;
validating payment authorization directly through the cloud platform using WiFi communication without routing through the mobile device as an intermediary;
upon successful validation, generating relay-driven pulse injection matching OEM coin pulse width, voltage, and rise/fall characteristics via an optocoupled relay module; and
providing visual diagnostic feedback via LED indicators indicating 12V input presence and microcontroller power-on state.

15. The method of claim 14, wherein monitoring transaction signals comprises interfacing directly with coin and bill acceptor outputs via JST-XH parallel tap connector interfaces, operating in parallel with existing machine control circuitry, and enabling simultaneous signal detection by both legacy machine systems and a unified electronic control board without interrupting OEM wiring.

16. The method of claim 14, wherein generating relay-driven pulse injection comprises analyzing pulse characteristics of actual mechanical coin insertions detected through listener inputs during a calibration phase and replicating exact electrical characteristics when generating simulated coin pulses via optocoupled relay output to ensure compatibility with legacy machine control systems.

17. The method of claim 14, further comprising processing bill/ticket acceptor signals through a third isolated JST-XH listener channel, identifying transaction values based on pulse patterns or serial data protocols, and uploading transaction data to the cloud platform in real-time for unified revenue tracking.

18. The method of claim 14, wherein validating payment authorization comprises verifying available funds through the cloud platform, transmitting an encrypted authorization signal directly to an ESP32-S3 microcontroller via WiFi, and eliminating latency associated with multi-hop routing through mobile devices as intermediaries.

19. A unified electronic control board (ECB) for retrofitting payment-operated machines, comprising:
an ESP32-S3 microcontroller with integrated WiFi capabilities;
three isolated listener input channels comprising JST-XH parallel tap connector interfaces configured to monitor a first coin mechanism via a first JST-XH parallel tap, monitor a second coin mechanism via a second JST-XH parallel tap, and monitor a bill/ticket acceptor via a third JST-XH parallel tap, wherein each listener input operates in parallel with existing machine control circuitry without interrupting OEM wiring;
a tri-modal power input interface comprising a barrel connector, a JST-XH power connector, and a JST-VH power connector;
a dual-relay configuration comprising first and second JQC3F-05VDC-C optocoupled relays providing independent control of monitoring and pulse generation functions; and
LED diagnostic indicators configured to indicate 12V input presence and microcontroller power-on state.

20. The unified ECB of claim 19, wherein the three isolated listener input channels comprise high-impedance listener inputs that draw negligible current from monitored signal lines, ensuring no signal degradation or voltage drop affecting operation of legacy machine control circuitry.

21. The unified ECB of claim 19, wherein each JST-XH parallel tap connector interface attaches to coin mechanisms and bill acceptors by utilizing Y-split adapter cables that enable parallel signal monitoring without interrupting the original signal path between payment mechanisms and machine control circuitry.

22. The unified ECB of claim 19, wherein the tri-modal power input interface incorporates integrated voltage regulation circuitry ensuring stable 3.3V and 5V rail voltages for microcontroller and relay operation regardless of selected power interface.

23. The unified ECB of claim 19, wherein the dual-relay configuration is configured such that when a cloud platform authorizes a digital payment transaction, the second optocoupled relay generates relay-driven pulse injection matching OEM coin pulse width, voltage, and rise/fall characteristics regardless of machine age or mechanical condition.

24. A method for non-invasively retrofitting a payment-operated machine with electronic payment capabilities, comprising:
installing three isolated listener inputs using JST-XH parallel taps by tapping into existing JST connector ports present on modern payment mechanisms or utilizing Y-split adapter cables that enable parallel signal monitoring without interrupting original signal paths,
wherein the listener inputs monitor two coin channels and one bill/ticket acceptor simultaneously without modifying existing machine circuitry;
connecting a power supply through one of three power input options comprising a barrel jack, a JST-XH connector, or a JST-VH connector;
calibrating a microcontroller to analyze pulse characteristics of actual mechanical coin insertions during a calibration phase; and
configuring the microcontroller to replicate exact electrical characteristics when generating simulated coin pulses via an optocoupled relay output;
wherein the installation preserves original machine functionality and wiring integrity.

25. The method of claim 24, further comprising verifying proper installation by observing LED diagnostic indicators indicating 12V input presence and microcontroller power-on state and configuring direct WiFi communication between an ESP32-S3 microcontroller and a cloud platform without requiring intermediary devices.
